(19) United States
(12) Patent Application Publication
(10) Pub. No.: US 2024/0029971 A1
(43) Pub. Date: Jan. 25, 2024

(54) OPERATION INPUT DEVICE

(71) Applicant: NIDEC PRECISION CORPORATION, Tokyo (JP)

(72) Inventor: Chikara YOKOTSUKA, Tokyo (JP)

(21) Appl. No.: 18/353,825

(22) Filed: Jul. 17, 2023

(30) Foreign Application Priority Data
Jul. 22, 2022 (JP) 2022-117367

(51) Int. Cl. H01H 21/36; H01H 21/22

(52) U.S. Cl. CPC H01H 21/36; H01H 21/22; H01H 2215/05

(57) ABSTRACT

An operation input device includes a button, a reaction generator, and a drive. The button includes an operation surface to be depressed by a user and a first contact located opposite to the operation surface. The button is rotatable about a first rotation axis. The reaction generator includes a second contact to be in contact with the first contact. The reaction generator is rotatable about a second rotation axis. The drive applies, to the reaction generator, a drive force for causing rotation about the second rotation axis. The drive applies, to the button, through the second contact and the first contact, a reaction force in a direction opposite to a direction in which the operation surface of the button is depressed. The second rotation axis is located outward from the first contact in a radial direction from the first rotation axis.

### RELATED APPLICATIONS

The present application claims priority to Japanese Application Number 2022-117367, filed Jul. 22, 2022, the disclosure of which is hereby incorporated by reference herein in its entirety.

### BACKGROUND

### Technical Field

The present invention relates to an operation input device.

### Description of the Background

For example, Patent Literature 1 describes an operation input device for receiving input operations for use in, for example, a gaming apparatus. The operation input device described in Patent Literature 1 includes a button to receive an input trigger operation, a reaction generator for applying a reaction force to the button, and a drive for driving the reaction generator. In this operation input device, the reaction generator driven by the drive provides haptic feedback to a fingertip of an operator operating the button based on the reaction force transmitted from the button.

### CITATION LIST

### Patent Literature

Patent Literature 1: WO 2019/142918

### BRIEF SUMMARY

The operation input device described in Patent Literature 1 is limited by the installation position of the reaction generator that applies a reaction force to the button, and may not allow sufficient miniaturization and design freedom.

In response to the above circumstances, one or more aspects of the present invention are directed to an operation input device that can be miniaturized and have higher design freedom.

An operation input device according to an aspect of the present invention includes a button, a reaction generator, and a drive. The button includes an operation surface to be depressed by a user and a first contact located opposite to the operation surface. The button is rotatable about a first rotation axis. The reaction generator includes a second contact to be in contact with the first contact. The reaction generator is rotatable about a second rotation axis. The drive applies, to the reaction generator, a drive force for causing rotation about the second rotation axis. The drive applies, to the button, through the second contact and the first contact, a reaction force in a direction opposite to a direction in which the operation surface of the button is depressed. The second rotation axis is located outward from the first contact in a radial direction from the first rotation axis.

The operation input device according to the above aspect of the present invention can be miniaturized and have higher design freedom.

### BRIEF DESCRIPTION OF DRAWINGS

FIG. 1 is a cross-sectional view of an operation input device according to a first embodiment.

FIG. 2 is a perspective view of the operation input device according to the first embodiment.

FIG. 3 is a block diagram of an operable device that is operable using the operation input device according to the first embodiment.

FIG. 4 is a cross-sectional view of the operation input device according to the first embodiment in use.

FIG. 5 is a cross-sectional view of an operation input device according to a modification of the first embodiment.

FIG. 6 is a cross-sectional view of an operation input device according to a second embodiment.

### DETAILED DESCRIPTION

In the drawings, Z-axis indicates a direction along an axis L (L1 to L3) that serves as a reference for an operation input device according to one or more embodiments. A direction radial from the axis L is hereafter simply referred to as a radial direction. A direction circumferential about the axis L is hereafter simply referred to as a circumferential direction.

### First Embodiment

An operation input device described below is installed in, for example, a target controller that receives an input operation performed by a user on an operation target displayed by, for example, a gaming apparatus to operate the operation target. An operation input device according to a first embodiment applies a reaction force to a button in response to the state of the operation target to provide haptic feedback to the user.

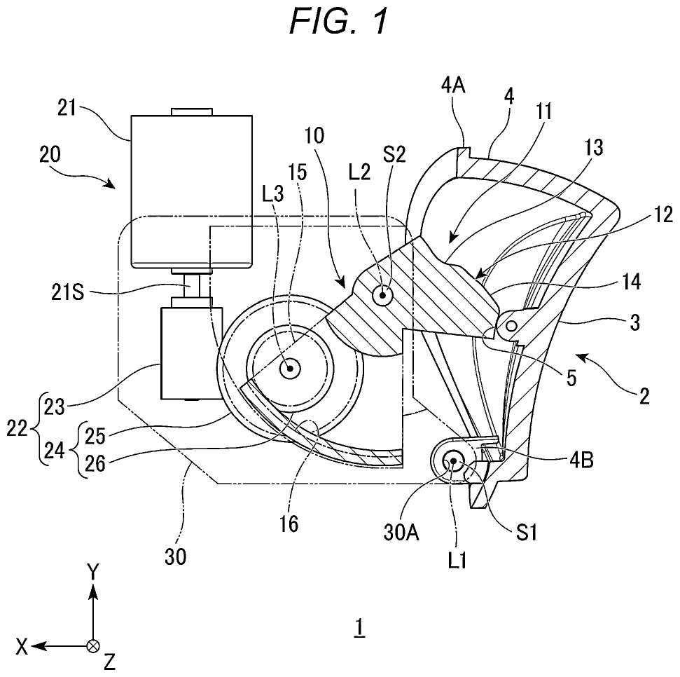

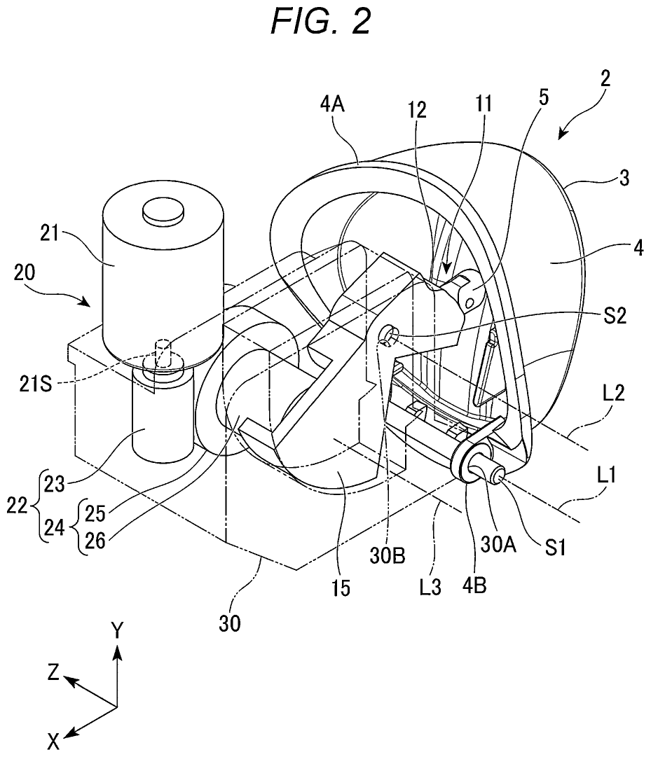

As shown in FIGS. 1 and 2, an operation input device 1 includes a button 2 to receive an input user operation, a button support 30 supporting the button 2, a reaction generator 10 for applying a reaction force to the button 2, and a drive 20 for driving the reaction generator 10. The button support 30 is a part of a housing (not shown) of the target controller. The button 2 is in the shape of, for example, a trigger. The target controller may include a single button 2 or two or more buttons 2.

The button 2 has an operation surface 3 to be depressed by the user. The operation surface 3 is to be touched by a fingertip of the user. The operation surface 3 is surrounded by a peripheral wall 4. The peripheral wall 4 has a flange 4A on its edge. The flange 4A comes in contact with, for example, the housing of the target controller to restrict the movement of the button 2. The button 2 includes a first shaft S1 that is supported by a pair of first shaft supports 4B located behind the operation surface 3. Each first shaft support 4B protrudes behind the operation surface 3. The pair of first shaft supports 4B support the first shaft S1, which is a rod.

The first shaft S1 extends along a first rotation axis L1. The first shaft S1 has two ends supported in first through-holes 30A in the button support 30. The first shaft S1 is rotatably supported by the pair of first shaft supports 4B and fitted in the first through-holes The first shaft S1 may be fitted in the pair of first shaft supports 4B and may be rotatably supported in the first through-holes 30A.

In the above structure, the button 2 is rotatable about the first rotation axis L1 relative to the button support 30 with the first shaft S1. The button 2 includes a spring for applying a reaction force to return the button 2 to its original position in response to a depressing operation performed on the button 2 in the direction of rotation about the first rotation axis L1. A first contact 5 is located on, of the surfaces facing a space defined by the peripheral wall 4, the surface opposite to the operation surface 3 in the circumferential direction. The first contact 5 protrudes in the circumferential direction. In the examples of FIGS. 1 and 2, the first contact has its distal end in contact with the reaction generator 10.

The reaction generator 10 is located on the button support 30 in a manner rotatable about a second rotation axis L2. The second rotation axis L2 extends parallel to the first rotation axis L1. The second rotation axis L2 is located outward from the first contact 5 in the radial direction from the first rotation axis L1. The reaction generator 10 includes a cam 11 that is rotatable about the second rotation axis L2. The reaction generator 10 includes a second shaft S2 having its axis aligned with the second rotation axis L2. The second shaft S2 may be integral with or separate from the reaction generator 10. The second shaft S2 has two ends rotatably supported in a pair of second through-holes 30B in the button support 30.

The cam 11 is located outward in the radial direction from the second rotation axis L2. The cam 11 includes a second contact 12 on an outward end in the radial direction. The second contact 12 comes in contact with the first contact 5. The second contact 12 is located within a predetermined range in the circumferential direction about the second rotation axis L2. The second contact 12 is a cam surface with its position in the radial direction from the second rotation axis L2 changeable about the second rotation axis L2. The second contact 12 includes a recess 13 recessed inward in the radial direction from the second rotation axis L2, and a protrusion 14 protruding outward in the radial direction from the second rotation axis L2. The second contact 12 may include either the recess 13 or the protrusion 14, or may include two or more recesses 13 and two or more protrusions 14.

In the above structure, the button 2 is depressed to have the first contact 5 and the second contact 12 in contact with each other. When the cam 11 rotates about the second rotation axis L2 in this state, the first contact 5 in the button 2 moves along the second contact 12 as the cam surface. The first contact 5 moves over the protrusion 14 and the recess 13 with its distance to the second rotation axis L2 changing in the radial direction from the second rotation axis L2, and the angle of rotation of the button 2 changing about the first rotation axis L1.

The reaction generator 10 includes a gear 15 having its axis aligned with the second rotation axis L2. The gear 15 is located opposite to the cam 11 in the radial direction from the second rotation axis L2. The gear 15 is, for example, an internal gear with internal teeth 16. The internal teeth 16 protrude inward in the radial direction from the second rotation axis L2. In some embodiments, the gear 15 may be an external gear. The gear 15 with the internal teeth 16 produces higher torque than an external gear, and also allows device miniaturization. The internal teeth 16 include the number of teeth determined based on a predetermined pitch that allows the cam 11 to rotate about the second rotation axis L2 within a predetermined range of angles. The gear 15 meshes with a second pinion gear 26 (described later) included in the drive 20.

The drive 20 applies, to the reaction generator 10, a drive force for causing rotation about the second rotation axis L2. The drive 20 includes, for example, a motor 21 as a drive source for outputting rotation, and a reducer 22 that transmits the rotation output from the motor 21 to the gear 15. The button support 30 supports the motor 21. The motor 21 is, for example, a stepper motor. The motor 21 includes an output shaft 21S for outputting rotation. The output shaft 21S in the motor 21 extends in a direction perpendicular to the first rotation axis L1 and the second rotation axis L2.

The reducer 22 includes, for example, a worm gear 23 located on the output shaft 21S and a pinion gear 24 rotatable when driven by the worm gear 23. The pinion gear 24 is rotatably supported by the button support 30. The pinion gear 24 includes a first pinion gear and the second pinion gear 26 as a two-stage coaxial gearbox.

The worm gear 23 includes helical teeth and is rotatable when driven by the output shaft 21S in the motor 21. The worm gear 23 meshes with the first pinion gear 25, which serves as a worm wheel. The first pinion gear 25 rotates about a third rotation axis L3 extending in the same direction as the first rotation axis L1. The first pinion gear 25 is rotatably supported by the button support 30. The first pinion gear 25 includes the second pinion gear 26 having its axis aligned with the third rotation axis L3. The first pinion gear 25 and the second pinion gear 26 are integral with each other. The second pinion gear 26 includes fewer teeth than the first pinion gear 25. The second pinion gear 26 rotates in cooperation with the rotation of the first pinion gear 25. The second pinion gear 26 meshes with the gear 15 included in the reaction generator 10.

In the above structure, a drive force for causing rotation that is output from the output shaft 21S in the motor 21 is transmitted to the worm gear 23. As the worm gear 23 rotates, the first pinion gear 25 meshing with the worm gear 23 rotates. The second pinion gear 26 rotates about the third rotation axis L3 in cooperation with the rotation of the first pinion gear 25. The rotational speed of the worm gear 23 is adjusted by the motor 21 to cause the gear 15 to rotate within a predetermined range of rotation angles.

In the above structure, the drive 20 outputs, from the output shaft 21S, rotation for driving and rotating the reaction generator 10 through the reducer 22. The drive 20 includes the second pinion gear 26 (pinion gear 24) that meshes with the gear 15. The drive 20 drives and rotates the second pinion gear 26 to apply, to the reaction generator 10, a drive force for causing rotation about the second rotation axis L2. The drive 20 applies, through the second contact 12 and the first contact 5, a reaction force to the button 2 in a direction opposite to a direction in which the operation surface 3 of the button 2 is depressed.

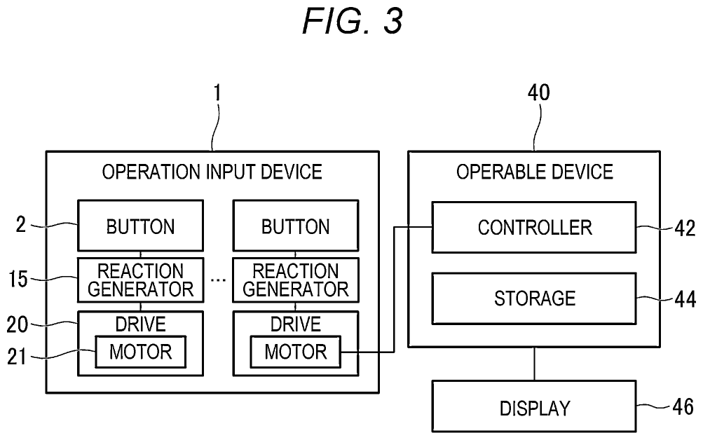

As shown in FIG. 3, the operation input device 1 in use is connected to an operable device 40 including a display 46. For example, the operable device 40 may be a gaming apparatus, a personal computer, a mobile terminal such as a smartphone, or a simulation apparatus. The operable device 40 displays an operation target on the display 46, such as a liquid crystal display. The display 46 may be integral with the operable device 40. A power supply (not shown) supplies power to the operation input device 1, the operable device 40, and the display 46.

The operation input device 1 is connected to the operable device 40 with, for example, a cable. The operation input device 1 outputs, to the operable device 40, an input signal based on an operation performed on the button 2. The operation input device 1 may be connected wirelessly to the operable device 40 to allow communication between the operation input device 1 and the operable device 40. In this case, the operation input device 1 may additionally include a communicator (not shown) that communicates with the operable device 40 and a power supply (not shown) that supplies power.

The operable device 40 includes, for example, a controller 42 that controls an operation target and a storage 44 for storing information for controlling the operation target. The storage 44 is a storage medium, such as a hard disk drive (HDD) or a flash memory. The storage 44 stores programs and data for operating an operation target.

The controller 42 is implemented by a processor such as a central processing unit (CPU) or a graphics processing unit (GPU) executing programs (software). These functional components may be partly or entirely implemented by hardware such as a large-scale integration (LSI) circuit, an application-specific integrated circuit (ASIC), or a field-programmable gate array (FPGA), or by software and hardware cooperating with each other. The programs may be prestored in a storage device such as an HDD or a flash memory included in the storage 44, or may be stored in a removable storage medium such as a digital versatile disc (DVD) or a compact disc read-only memory (CD-ROM). The removable storage medium may be mounted on a drive device to cause such programs to be installed in the storage device. The controller 42 causes the display 46 to display an operation target and controls the motor 21 in the drive 20. The controller 42 controls the motor 21 to adjust the drive force for causing rotation to be applied to the reaction generator 10 based on the degree of operation performed on the operation surface 3 of the button 2 in response to the state of the operation target. The controller 42 thus adjusts the reaction force generated on the operation surface 3.

For example, the controller 42 energizes the motor 21 and drives the reaction generator 10 to apply a reaction force to the button 2. The controller 42 energizes the motor 21 in a direction to, for example, cause the depressed button 2 to return to the original position. The controller 42 detects the amount of operation (degree of operation) performed on the button 2 based on the load on the motor 21 in response to the operation on the button 2 and detects the rotation angle of a rotor (not shown) connected to the output shaft 21S. The controller 42 adjusts power supplied to the motor 21 based on the state of the operation target appearing on the display 46, the amount of operation performed on the button 2, and the rotation angle of the rotor, and adjusts the rotation angle of the rotor. The controller 42 may detect the amount of operation performed on the button 2 with an angle sensor (not shown) additionally mounted on the button 2.

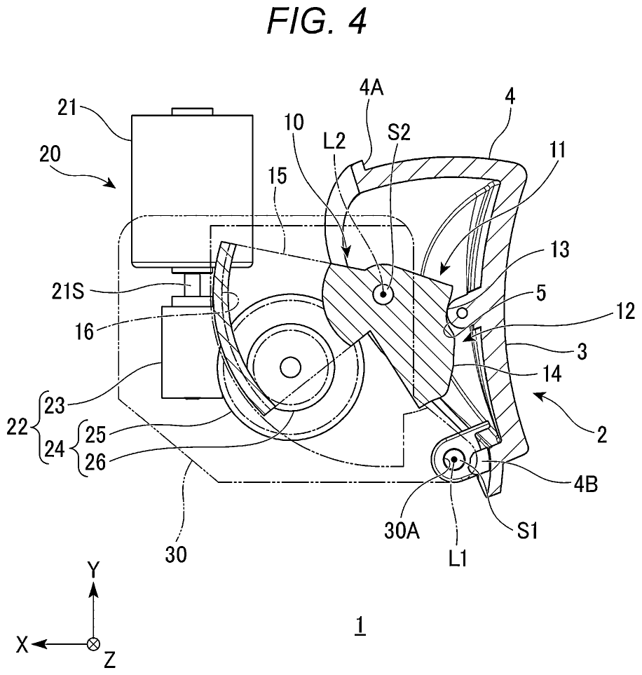

As shown in FIG. 4, the controller 42 rotates the reaction generator 10 by controlling the motor 21 in response to the state of the operation target to adjust the position of the second contact 12 in contact with the first contact 5. The controller 42 controls the motor 21 to place the first contact 5 into contact with the recess 13 or the protrusion 14 in response to the state of the operation target to change the sensation of haptic feedback on the operation surface 3 of the button 2. The controller 42 may rotate the reaction generator 10 in response to the state of the target operation by controlling the motor 21 to provide haptic feedback such as a reaction force, vibrations, or impact on the operation surface 3 of the button 2.

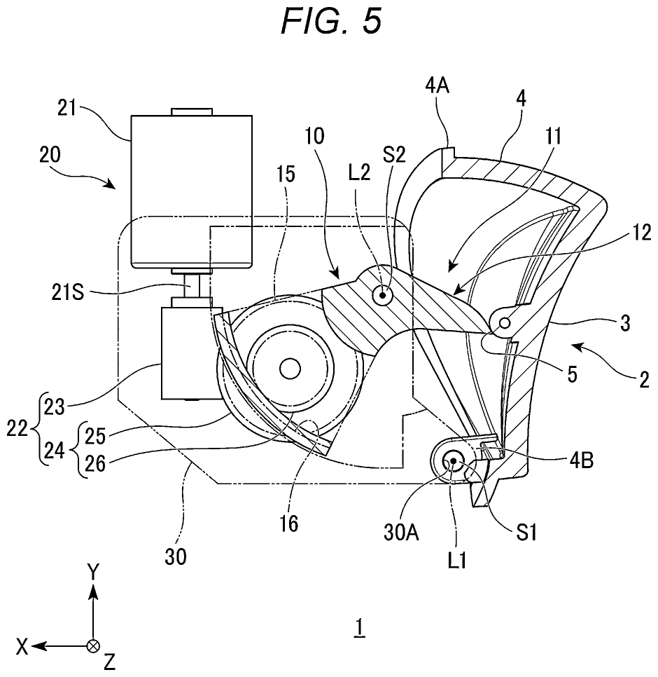

The motor 21 and the reducer 22 may perform backdriving to generate a reaction force corresponding to the amount of operation performed on the button 2 in response to an operation on the button 2 in the deenergized state of the motor 21. The reaction generator 10 may include a spring for applying a restoring force to the button 2 to cause the button 2 to rotate about the second rotation axis L2 and return to the original position when the button 2 is depressed. As shown in FIG. 5, the second contact 12 in the cam 11 may be a smooth cam surface without any recess 13 or any protrusion 14.

As described above, the operation input device 1 can provide haptic feedback on the operation surface 3 of the button 2 based on rotation of the reaction generator 10 including the cam 11. In the operation input device 1, the second rotation axis L2 about which the cam 11 rotates is located outward from the first contact 5 in the radial direction from the first rotation axis L1 of the button 2. Unlike a second rotation axis L2 located inward from the first contact in the radial direction from the first rotation axis L1, the second rotation axis L2 can be placed more flexibly, thus increasing the flexibility in placing the reaction generator 10 that rotates about the second rotation axis L2. The second rotation axis L2 is located outward from the first contact 5 in the radial direction from the first rotation axis L1. As the button 2 is depressed about the first rotation axis L1, the reaction generator 10 rotating about the second rotation axis L2 moves in a direction different from the direction in which the button 2 is depressed. This structure eliminates a space for accommodating the reaction generator 10 in the direction in which the button 2 is depressed, unlike the structure including the reaction generator 10 that moves in the direction in which the button 2 is depressed. The operation input device 1 can thus be miniaturized easily. More specifically, as shown in FIG. 4, the reaction generator 10 in the present embodiment can be partially accommodated in the space defined by the peripheral wall 4 of the button 2 when the button 2 is depressed. This structure reduces the likelihood of a larger space being provided for accommodating the reaction generator 10. The operation input device 1 can thus be miniaturized. As described above, the operation input device 1 according to the present embodiment can be miniaturized and have higher design freedom.

In the operation input device 1, the reaction generator 10 includes the cam 11. The position of the second contact 12 as the cam surface to come in contact with the first contact 5 is changeable based on the position of the button 2 to slightly change the sensation of haptic feedback. In the operation input device 1, the reaction generator 10 includes the cam 11. The second contact 12 as the cam surface easily provides more direct sensation when the button 2 is operated. In the operation input device 1, the second contact 12 includes the recess 13 and the protrusion 14 to easily provide various sensations of haptic feedback on the operation surface 3 of the button 2.

### Second Embodiment

An operation input device according to a second embodiment will now be described. The components that are the same as in the first embodiment are given the same names and reference numerals herein and will not be described repeatedly.

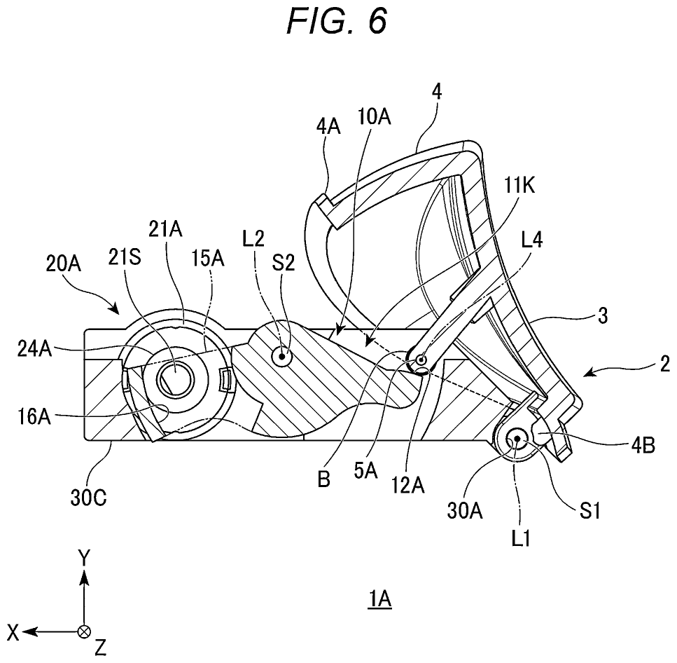

As shown in FIG. 6, an operation input device 1A according to the second embodiment includes a reaction generator 10A including a lever 11K that rotates about a second rotation axis L2. The lever 11K includes a second contact 12A on its distal end. A first contact 5A is in contact with a portion of the second contact 12A in the circumferential direction about the second rotation axis L2. The first contact 5A receives, on its distal end, a bearing B supported rotatably about a fourth rotation axis L4 extending in a direction along the first rotation axis L1. The bearing B is, for example, a ball bearing. The bearing B may be another type of bearing.

In some embodiments, the bearing B may be located on a distal end of the second contact 12A. In other words, the bearing B may be located on at least one of the first contact or the second contact 12A. A first distance from the first rotation axis Ll of the button 2 to the first contact 5A is substantially equal to a second distance from the second rotation axis L2 of the lever 11K to the second contact 12A. The first contact 5A and the second contact 12A are located to cause the first distance and the second distance to be substantially equal to each other. In some embodiments, the first distance and the second distance may be different from each other.

The reaction generator 10A includes a gear 15A having its axis aligned with the second rotation axis L2. The gear 15A is located opposite to the lever 11K in the radial direction from the second rotation axis L2. The gear 15A is, for example, an internal gear with internal teeth 16A. The internal teeth 16A protrude inward in the radial direction from the second rotation axis L2. In some embodiments, the gear 15A may be an external gear. The gear 15A with the internal teeth 16A produces higher torque than an external gear, and also allows device miniaturization. The internal teeth 16A include the number of teeth determined by a predetermined pitch that allows the lever 11K to rotate about the second rotation axis L2 within a predetermined range of angles. The gear 15A meshes with a pinion gear 24A included in a drive 20A.

The drive 20A includes, for example, the pinion gear 24A for transmitting, to the gear 15A, rotation output from a motor 21A as a drive source. The motor 21A is supported by a button support 30C. The motor 21A includes an output shaft 21S for outputting rotation. The output shaft 21S in the motor 21A extends along the first rotation axis L1 and the second rotation axis L2. The pinion gear 24A is coaxially located on the output shaft 21S.

In the above structure, a drive force for causing rotation that is output from the output shaft 21S in the motor 21A is transmitted to the pinion gear 24A. As the pinion gear 24A rotates, the gear 15A meshing with the pinion gear 24A rotates about the second rotation axis L2. The rotation angle of the pinion gear 24A is adjusted to allow the gear 15A to rotate within a range of rotation angles.

In the above structure, the drive 20A outputs, from the output shaft 21S, rotation for driving and rotating the reaction generator 10A through the pinion gear 24A. The drive 20A drives and rotates the pinion gear 24A to apply, to the reaction generator 10A, a drive force for causing rotation about the second rotation axis L2. The drive 20A applies, through the second contact 12A, the bearing B, and the first contact 5A, a reaction force to the button 2 in the direction opposite to the direction in which the operation surface 3 of the button 2 is depressed.

In the operation input device 1A according to the second embodiment, the reaction generator 10A includes the lever 11K including the second contact 12A on its distal end. The first contact 5A is in contact with the second contact 12A in the circumferential direction about the second rotation axis L2. When the button 2 is depressed to rotate about the first rotation axis L1, the second contact 12A is depressed in the circumferential direction about the second rotation axis L2, and the reaction generator 10A rotates about the second rotation axis L2. In this case, the distance from the second rotation axis L2 to the first contact 5A is less likely to change in the radial direction from the second rotation axis L2. Thus, the moment of the reaction force applied from the reaction generator 10A to the first contact 5A is less likely to change, independently of the rotational position of the button 2. This allows the reaction generator 10A to generate a substantially constant reaction force to be transmitted to the button 2 independently of the rotational position of the button 2, without adjusting the force applied from the drive 20A to the reaction generator 10A based on the rotational position of the button 2. This simplifies the control of the drive 20A. The operation input device 1A includes the bearing B for a rotational shaft either on the first contact 5A or on the second contact 12A to reduce frictional loss that may occur from the first contact 5A and the second contact 12A in contact with each other.

The technique may provide the structures described below. p1 (1) An operation input device, comprising:
a button including an operation surface to be depressed by a user and a first contact located opposite to the operation surface, the button being rotatable about a first rotation axis;
a reaction generator including a second contact to be in contact with the first contact, the reaction generator being rotatable about a second rotation axis; and
a drive configured to apply, to the reaction generator, a drive force for causing rotation about the second rotation axis,
wherein the drive applies, to the button, through the second contact and the first contact, a reaction force in a direction opposite to a direction in which the operation surface of the button is depressed, and
the second rotation axis is located outward from the first contact in a radial direction from the first rotation axis.
(2) The operation input device according to (1), wherein
the reaction generator includes a reaction gear having an axis aligned with the second rotation axis, and
the drive includes a pinion gear meshing with the reaction gear, and drives and rotates the pinion gear to apply, to the reaction generator, a drive force for causing rotation about the second rotation axis.
(3) The operation input device according to (1) or (2), wherein
the second contact is a cam surface at a position in a radial direction from the second rotation axis changeable about the second rotation axis.
(4) The operation input device according to (3), wherein
the cam surface includes at least one of a recess recessed inward in the radial direction from the second rotation axis or a protrusion protruding outward in the radial direction from the second rotation axis.
(5) The operation input device according to (1) or (2), wherein
the reaction generator includes a lever including the second contact on a distal end of the reaction generator, and
the first contact comes in contact with the second contact in a circumferential direction about the second rotation axis.
(6) The operation input device according to (1) or (2), wherein
at least one of the first contact or the second contact includes a bearing supported rotatably about a fourth rotation axis extending in a direction along the first rotation axis.

(7) The operation input device according to any one of (1) to (6), further comprising:
a reducer between the drive and the reaction generator, the reducer being configured to perform backdriving to generate a reaction force corresponding to an amount of operation performed on the button in response to an operation performed on the button in a deenergized state of the drive.
(8) The operation input device according to any one of (1) to (7), further comprising:
a controller configured to control the drive,
wherein the controller adjusts a drive force for causing rotation to be applied to the reaction generator based on a degree of operation performed on the operation surface in response to a state of an operation target, and adjusts a reaction force generated on the operation surface.

The structures and methods described herein may be combined as appropriate unless any contradiction arises. For example, the operation input device 1 according to the first embodiment may include the bearing B.

What is claimed is:

1. An operation input device, comprising:
a button including an operation surface to be depressed by a user and a first contact located opposite to the operation surface, the button being rotatable about a first rotation axis;
a reaction generator including a second contact to be in contact with the first contact, the reaction generator being rotatable about a second rotation axis; and
a drive configured to apply, to the reaction generator, a drive force for causing rotation about the second rotation axis,
wherein the drive applies, to the button, through the second contact and the first contact, a reaction force in a direction opposite to a direction in which the operation surface of the button is depressed, and
the second rotation axis is located outward from the first contact in a radial direction from the first rotation axis.

2. The operation input device according to claim 1, wherein
the reaction generator includes a reaction gear having an axis aligned with the second rotation axis, and
the drive includes a pinion gear meshing with the reaction gear, and drives and rotates the pinion gear to apply, to the reaction generator, a drive force for causing rotation about the second rotation axis.

3. The operation input device according to claim 1, wherein
the second contact is a cam surface at a position in a radial direction from the second rotation axis changeable about the second rotation axis.

4. The operation input device according to claim 3, wherein
the cam surface includes at least one of a recess recessed inward in the radial direction from the second rotation axis or a protrusion protruding outward in the radial direction from the second rotation axis.

5. The operation input device according to claim 1, wherein
the reaction generator includes a lever including the second contact on a distal end of the reaction generator, and
the first contact comes in contact with the second contact in a circumferential direction about the second rotation axis.

6. The operation input device according to claim 1, wherein
at least one of the first contact or the second contact includes a bearing supported rotatably about a fourth rotation axis extending in a direction along the first rotation axis.

7. The operation input device according to claim 1, further comprising:
a reducer between the drive and the reaction generator, the reducer being configured to perform backdriving to generate a reaction force corresponding to an amount of operation performed on the button in response to an operation performed on the button in a deenergized state of the drive.

8. The operation input device according to claim 1, further comprising:
a controller configured to control the drive,
wherein the controller adjusts a drive force for causing rotation to be applied to the reaction generator based on a degree of operation performed on the operation surface in response to a state of an operation target, and adjusts a reaction force generated on the operation surface.
